(19) United States
(12) Patent Application Publication
(10) Pub. No.: US 2024/0336738 A1
(43) Pub. Date: Oct. 10, 2024

(54) RESIN COMPOSITION, POLYIMIDE PREPARATION METHOD AND RELATED PRODUCTS

(71) Applicant: AAC Technologies (Nanjing) Co., Ltd., Nanjing (CN)

(72) Inventors: Yilan Zhang, Nanjing (CN); Hongyuan Wang, Nanjing (CN); Hezhi Wang, Nanjing (CN)

(21) Appl. No.: 18/402,739

(22) Filed: Jan. 3, 2024

Related U.S. Application Data
(63) Continuation of application No. PCT/CN2023/091051, filed on Apr. 27, 2023.

(30) Foreign Application Priority Data
Apr. 6, 2023 (CN) 202310359686.2

(51) Int. Cl. C08G 73/10; C08G 59/32; C08K 5/26; C08K 5/29; C08K 5/315; C08K 5/3492; C09J 179/08

(52) U.S. Cl. CPC C08G 73/1082; C08G 59/32; C08G 73/1021; C08G 73/1032; C08K 5/26; C08K 5/29; C08K 5/3155; C08K 5/34922; C09J 179/08; C08G 2170/00; C09J 2400/163; C09J 2479/08

(57) ABSTRACT

The present invention provides a resin composition, a polyimide preparation method and related products. The resin composition consists of the following components: polyimide which is a soluble product generated by a reaction of monomer groups containing aromatic tetracarboxylic dianhydride and diacid dihydrazide, a main chain of the polyimide containing a hydrazide structure; and a curing agent which comprises one or more of multifunctional epoxy resin, a primary amine compound with three or more functional groups, and polyisocyanate, wherein a mass ratio of the curing agent to the soluble polyimide is 0-20%. The resin composition in the present invention utilizes the hydrazide structure in the polyimide to prepare an adhesive with excellent heat resistance, adhesive performance, and solubility, overcoming the shortcomings of existing polyimide-based adhesives during processing or application.

### TECHNICAL FIELD

The present invention belongs to the technical field of electronic adhesives, and particularly relates to a resin composition, a polyimide preparation method and related products.

### BACKGROUND

Polyimide-based adhesives can be used in the fields of high-frequency transmission, insulation packaging, wafer-level chip packaging and rewiring, enamelled wire coating, and copper clad laminates due to their insulating properties and good adhesive performance.

However, existing polyimide-based adhesives often face a contradiction between temperature resistance and adhesive performance. Adhesives with good temperature resistance often contain a large number of rigid structures in their chemical structure, which can reduce the adhesive performance and solubility with metals or other substrates, resulting in poorer processing performance and usability. Conversely, introducing a significant number of flexible groups in the structure can effectively improve the adhesive performance of the polyimide-based adhesives, but it often leads to a decrease of the heat resistance and an increase of the coefficient of thermal expansion (CTE), and reduces the reliability during subsequent processing and usage.

### SUMMARY

The present invention aims to provide a resin composition to address the issue that existing polyimide-based adhesives cannot maintain excellent temperature resistance and adhesive performance.

In a first aspect, the present invention provides a resin composition, consisting of the following components:
polyimide which is a soluble product generated by a reaction of monomer groups containing aromatic tetracarboxylic dianhydride and diacid dihydrazide, a main chain of the polyimide containing a hydrazide structure; and
a curing agent which comprises one or more of multifunctional epoxy resin, a primary amine compound with three or more functional groups, and polyisocyanate, wherein a mass ratio of the curing agent to the soluble polyimide is 0-20%.

Further, a structural formula of the soluble polyimide is as follows:

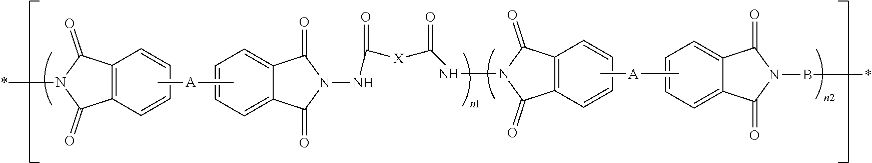

where, -A- is a dianhydride functional group, and the dianhydride functional group is one or more of phenyl whose bridging group is alkyl, ether, alkoxy, alkyl ester, carbonyl, sulphonyl, thioether or a group whose side chain has —H, alkyl, hydroxyl, fluorine and alkyl fluorine;
-B- is a diamine functional group, and the diamine functional group is any one of diphenylamine whose bridging group is long-chain alkyl, long-chain alkoxy or long-chain alkyl and long-chain alkoxy with branched structures; and

-X- is —(CH₂)ₘ- or a phenyl group with pendant groups, and m is an integer between 0 and 6.

Further, the number of carbon atoms of the alkyl and the alkoxy is 0-20.

Further, the multifunctional epoxy resin is one of bisphenol S epoxy resin, bisphenol F epoxy resin, polyglycidyl ether epoxy resin, aliphatic glycidyl ether epoxy resin and glycidyl ester epoxy resin.

Further, a structural formula of the multifunctional epoxy resin is as follows:

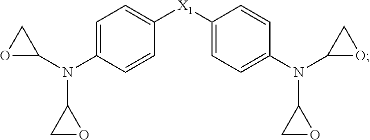

or

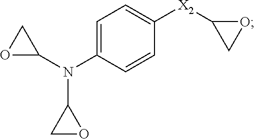

where, X1 and X2 are each one of —,O—, alkyl, alkoxy, alkylphenyl and alkylphenoxy.

Further, the primary amine compound with three or more functional groups is one of melamine, semicarbazide and dicyandiamide.

Further, the polyisocyanate is one of toluene diisocyanate, diphenylmethane diisocyanate, isophorone diisocyanate, hexamethylene diisocyanate, dicyclohexylmethane diisocyanate, naphthalene diisocyanate, 1,4-phenylene diisocyanate, diphenylmethylene diisocyanate, cyclohexanedimethylene diisocyanate, trimethyl-1,6-hexamethylene diisocyanate, tetramethyl m-xylylene diisocyanate, norbornane diisocyanate, dimethylbiphenyl diisocyanate, methylcyclohexyl diisocyanate and dimers or trimers thereof.

In a second aspect, the present invention provides a polyimide preparation method, polyimide here is the polyimide in the above resin composition, and the polyimide preparation method comprises the following steps:
S1, firstly dissolving diamine and dihydrazide in a solvent, then adding dianhydride, and then reacting at a first preset temperature for a first preset time, to synthesize polyamic acid with a hydrazide structure in a main chain; and
S2, adding a water-carrying agent or a catalyst into the polyamic acid with the hydrazide structure in the main chain, and then reacting at a second preset temperature for a second preset time, to obtain the soluble polyimide with the hydrazide structure.

Further, a molar ratio of the dianhydride, the diamine and the long-chain dihydrazide is 0.95-1.3:0-1:0.05-0.6, and a molar ratio of the dianhydride to the diamine plus the long-chain dihydrazide is greater than 0.95 and less than or equal to 1.3.

Further, the first preset temperature is −20-50° C., the first preset time is 1-48 h, the second preset temperature is 140-280° C., and the second preset time is 0.5-10 h.

Further, the diamine is diamine with the -B- structure; and the diamine is one of more of 4,4-diaminodiphenyl ether, 3,4-diaminodiphenyl ether, 2,2-bis[4-(4-aminophenoxy)phenyl]propane, 1,3-bis(3-aminophenoxy)benzene, 1,3-bis(4-aminophenoxy) benzene, 1,4-bis(4-aminophenoxy)benzene, 2,2′-bis(trifluoromethyl)-4,4′-diaminophenyl ether, 2,2-bis(3-amino-4-hydroxyphenyl)hexafluoropropane, 2,2-bis(4-hydroxy-3-aminophenyl)propane, 4,4′-bis(3-aminophenoxy) diphenyl sulfone, 4-aminobenzoic acid 4-aminophenyl ester, [4-(4-aminobenzoyl)phenoxy]4-aminobenzoic acid ester, and 1,4-bis(4-amino-2-trifluoromethylphenoxy)benzene.

Further, the long-chain dihydrazide is dihydrazide with the-X-structure; and the long-chain dihydrazide is one or more of maleic dihydrazide, glutaric dihydrazide, succinic dihydrazide, adipic dihydrazide, carbohydrazide, oxalyl dihydrazide, and N,N′-(2,2′-bis(trifluoromethyl)-[1,1′-biphenyl]-4,4′-diyl) bis(4-aminobenzamide).

Further, the dianhydride is dianhydride with the -A- structure; and the dianhydride is one or more of 4,4-oxydiphthalic anhydride, bisphenol A diether dianhydride, p-phenylene-trimellitate dianhydride, hexafluorodianhydride, 3,3,4,4-benzophenone tetracarboxylic dianhydride, 4,4′-diphenyl ether dianhydride and 3,3,4,4-diphenyl sulfone tetracarboxylic dianhydride.

Further, the solvent is one or more of toluene, xylene, dioxane, tetrahydrofuran, methanol, ethanol, acetone, butanone, cyclohexanone, N,N-dimethylformamide, N,N-dimethylacetamide and N-methylpyrrolidone.

Further, the water-carrying agent is one or more of benzene, toluene and xylene; and the catalyst is one of triethylamine, pyridine and isoquinoline liquid, with a boiling point less than 200°° C.

In a third aspect, the present invention provides an adhesive, comprising a solvent, a curing accelerator and the above resin composition. Here, a mass proportion of the resin composition in the adhesive is 10%-40%, a mass proportion of the curing accelerator in the adhesive is 0%-10%, and the balance is the solvent.

Further, polyimide in the resin composition is prepared by the above polyimide preparation method.

In a fourth aspect, the present invention provides an adhesive layer, comprising a support and the above resin composition applied to the support or the above adhesive.

In a fifth aspect, the present invention provides a copper foil with resin, comprising a copper foil and the above adhesive applied to the copper foil or the above adhesive layer.

Compared with the related art, in the resin composition of the present invention, the special hydrazide structure is used as the diamine component of the polyimide, allowing for the preparation of polyimide resin with excellent heat resistance, adhesive performance, and solubility. Moreover, by using the specific curing agent, the present invention enables the formulation of the adhesive with excellent heat resistance, adhesive performance, and solubility, overcoming the shortcomings of existing polyimide-based adhesives during processing or application.

### DETAILED DESCRIPTION OF EMBODIMENTS

In order to make the object, technical solutions and advantages of the present invention clearer, the following detailed description of the present invention is given in conjunction with attached drawings and embodiments. It should be understood that the specific embodiments described here are only for explaining the present invention, and do not limit the present invention.

An embodiment provides a resin composition, consisting of the following components:
polyimide which is a soluble product generated by a reaction of monomer groups containing aromatic tetracarboxylic dianhydride and diacid dihydrazide, a main chain of the polyimide containing a hydrazide structure; and
a curing agent which comprises one or more of multifunctional epoxy resin, a primary amine compound with three or more functional groups, and polyisocyanate, wherein a mass ratio of the curing agent to the soluble polyimide is 0-20%.

Specifically, a structural formula of the polyimide is as follows:

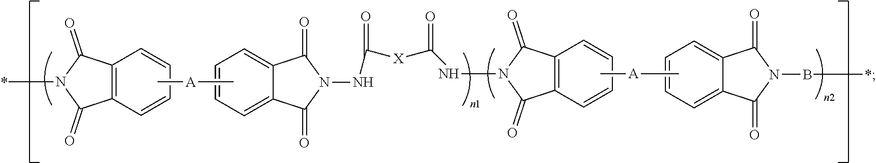

where, -A- is a dianhydride functional group, and the dianhydride functional group is one or more of phenyl whose bridging group is alkyl, ether, alkoxy, alkyl ester, carbonyl, sulphonyl, thioether or a group whose side chain has —H, alkyl, hydroxyl, fluorine and alkyl fluorine;

-B- is a diamine functional group, and the diamine functional group is any one of diphenylamine whose bridging group is long-chain alkyl, long-chain alkoxy or long-chain alkyl and long-chain alkoxy with branched structures; and

-X- is —(CH₂)ₘ- or a phenyl group with pendant groups, and m is an integer between 0 and 6.

The structural formula of the polyimide is a residual group after the reaction of diacid dihydrazide and anhydride.

A structural formula of the diacid dihydrazide is as follows:

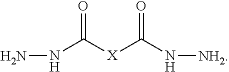

In this embodiment, the number of carbon atoms of the alkyl and the alkoxy is 0-20.

In this embodiment, the multifunctional epoxy resin is one of bisphenol S epoxy resin, bisphenol F epoxy resin, polyglycidyl ether epoxy resin, aliphatic glycidyl ether epoxy resin and glycidyl ester epoxy resin.

A structural formula of the multifunctional epoxy resin is as follows:

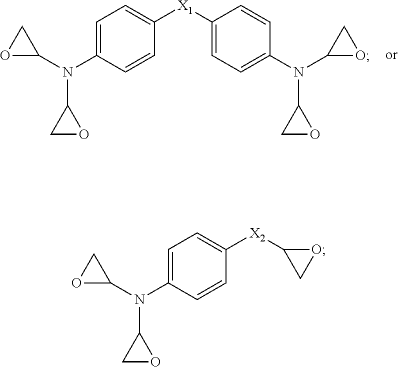

where, X₁ and X₂ are each one of —,O—, alkyl, alkoxy, alkylphenyl and alkylphenoxy.

In this embodiment, the primary amine compound with three or more functional groups is one of melamine, semicarbazide and dicyandiamide.

In this embodiment, the polyisocyanate is one of toluene diisocyanate, diphenylmethane diisocyanate, isophorone diisocyanate, hexamethylene diisocyanate, dicyclohexylmethane diisocyanate, naphthalene diisocyanate, 1,4-phenylene diisocyanate, diphenylmethylene diisocyanate, cyclohexanedimethylene diisocyanate, trimethyl-1,6-hexamethylene diisocyanate, tetramethyl m-xylylene diisocyanate, norbornane diisocyanate, dimethylbiphenyl diisocyanate, methylcyclohexyl diisocyanate and dimers or trimers thereof.

Compared with the related art, in the resin composition provided in this embodiment, the special hydrazide structure is used as the diamine component of the polyimide, allowing for the preparation of polyimide resin with excellent heat resistance, adhesive performance, and solubility. Moreover, by using the specific curing agent, the present invention enables the formulation of the adhesive with excellent heat resistance, adhesive performance, and solubility, overcoming the shortcomings of existing polyimide-based adhesives during processing or application. Furthermore, by using hydrazide as an amine source and introducing the amide structure into polyimide, synthesis can be realized in just one step, making the process simple and suitable for large-scale industrial production. This approach avoids the issues such as low molecular weight, difficult post-treatment, and complex process involved in the preparation of polyamide-imide using isocyanate or acyl chloride methods, thus having significant application value.

The present invention further provides an embodiment of a polyimide preparation method, polyimide here is the polyimide in the resin composition provided in the above embodiment, and the polyimide preparation method comprises the following steps:
S1, firstly dissolving diamine and long-chain dihydrazide in a solvent, then adding dianhydride, and then reacting at a first preset temperature for a first preset time, to synthesize polyamic acid with a hydrazide structure in a main chain; and
S2, adding a water-carrying agent or a catalyst into the polyamic acid with the hydrazide structure in the main chain, and then reacting at a second preset temperature for a second preset time, to obtain the soluble polyimide with the hydrazide structure.

In this embodiment, a molar ratio of the dianhydride, the diamine and the long-chain dihydrazide is 0.95-1.3:0-1:0.05-0.6, and a molar ratio of the dianhydride to the diamine plus the long-chain dihydrazide is greater than 0.95 and less than or equal to 1.3, that is, 0.95<the dianhydride: (the diamine+the long-chain dihydrazide)≤1.3.

In this embodiment, the first preset temperature is −20-50° C., the first preset time is 1-48 h, preferably, the first preset temperature is −20-40°° C., and the first preset time is 6-18 h; and the second preset temperature is 140-280° C., the second preset time is 0.5-10 h, preferably, the second preset temperature is 160-240° C., and the second preset time is 1-6 h.

In this embodiment, the diamine is diamine with the -B- structure; and the diamine is one of more of 4,4-diaminodiphenyl ether, 3,4-diaminodiphenyl ether, 2,2-bis[4-(4-aminophenoxy)phenyl]propane, 1,3-bis(3-aminophenoxy)benzene, 1,3-bis(4-aminophenoxy) benzene, 1,4-bis(4-aminophenoxy)benzene, 2,2′-bis(trifluoromethyl)-4,4′-diaminophenyl ether, 2,2-bis(3-amino-4-hydroxyphenyl)hexafluoropropane, 2,2-bis(4-hydroxy-3-aminophenyl)propane, 4,4′-bis(3-aminophenoxy)diphenyl sulfone, 4-aminobenzoic acid 4-aminophenyl ester, [4-(4-aminobenzoyl)phenoxy]4-aminobenzoic acid ester, and 1,4-bis(4-amino-2-trifluoromethylphenoxy)benzene.

In this embodiment, the long-chain dihydrazide is dihydrazide with the -X- structure; and the long-chain dihydrazide is one or more of maleic dihydrazide, glutaric dihydrazide, succinic dihydrazide, adipic dihydrazide, carbohydrazide, oxalyl dihydrazide, and N,N′-(2,2′-bis(trifluoromethyl)-[1,1′-biphenyl]-4,4′-diyl) bis(4-aminobenzamide).

In this embodiment, the dianhydride is dianhydride with the -A- structure; and the dianhydride is one or more of 4,4-oxydiphthalic anhydride, bisphenol A diether dianhydride, p-phenylene-trimellitate dianhydride, hexafluorodianhydride, 3,3,4,4-benzophenone tetracarboxylic dianhydride, 4,4′-diphenyl ether dianhydride and 3,3,4,4-diphenyl sulfone tetracarboxylic dianhydride.

In this embodiment, the solvent is one or more of toluene, xylene, dioxane, tetrahydrofuran, methanol, ethanol, acetone, butanone, cyclohexanone, N,N-dimethylformamide, N,N-dimethylacetamide and N-methylpyrrolidone.

In this embodiment, the water-carrying agent is one or more of benzene, toluene and xylene; and the catalyst is one of triethylamine, pyridine and isoquinoline liquid, with a boiling point less than 200° C.

The present invention further provides an embodiment of an adhesive, comprising a solvent, a curing accelerator and the resin composition provided in the above embodiment. Here, a mass proportion of the resin composition in the adhesive is 10%-40%, a mass proportion of the curing accelerator in the adhesive is 0%-10%, and the balance is the solvent.

In this embodiment, the solvent is the same as that used in the above polyimide preparation method, that is, the solvent is one or more of toluene, xylene, dioxane, tetrahydrofuran, methanol, ethanol, acetone, butanone, cyclohexanone, N,N-dimethylformamide, N,N-dimethylacetamide and N-methylpyrrolidone.

Further, polyimide in the resin composition is prepared by the above polyimide preparation method.

Since the adhesive in this embodiment contains the resin composition as described above, it can also achieve the technical effects achieved by the resin composition, which will not be repeated here.

In addition, the above resin composition can also be directly used as an adhesive, or the prepared soluble polyimide is mixed with a curing agent to be used as an adhesive directly, or the prepared soluble polyimide is mixed with a curing agent and a solvent to be used as an adhesive.

The present invention further provides an embodiment of an adhesive layer, comprising a support and the resin composition as in the above embodiment applied to the support, or the adhesive as in the above embodiment.

A preparation method for the adhesive layer is as follows: applying the resin composition or adhesive as in the above embodiment to the support, a thickness of the resin composition or adhesive being 2-25 μm; baking in a blasting oven at 180-220° C. for 3-8 min; and then removing resin composition or adhesive to obtain the adhesive layer.

Since the adhesive layer in this embodiment adopts the adhesive as described above, it can also achieve the technical effects achieved by the adhesive, which will not be repeated here.

The present invention further provides an embodiment of a copper foil with resin, comprising a copper foil and the adhesive as in the above embodiment applied to the copper foil, or the adhesive layer as in the above embodiment.

Since the copper foil with resin in this embodiment adopts the adhesive or adhesive layer as described above, it can also achieve the technical effects achieved by the adhesive or adhesive layer, which will not be repeated here.

In order to better explain the resin composition in the present invention, specific embodiments and comparative examples will be provided below. First, specific examples for the preparation of a polyimide solution is as follows.

Manufacturing example 1: Under the protection of N₂, 2.61 g of oxalyl dihydrazide (ADH), 7.01 g of 4,4-diaminodiphenyl ether (ODA) and 59.37 g of N-methylpyrrolidone were added into a three-necked flask for dissolution; after dissolution, 15.82 g of 4,4′-oxydiphthalic anhydride (ODPA) was slowly added, and the mixture reacted at room temperature for 6 h; then, the mixture was transferred into a single-neck flask equipped with a magnetic stirrer and a water separator, and 5 g of methylbenzene was added; and then the temperature was raised to 200° C. for reflux for 4 h to obtain a polyimide solution.

Manufacturing example 2: Under the protection of N₂, 2.61 g of oxalyl dihydrazide (ADH), 7.01 g of 4,4-diaminodiphenyl ether (ODA) and 84.39 g of N-methylpyrrolidone were added into a three-necked flask for dissolution; after dissolution, 26.54 g of bisphenol A diether dianhydride (BPADA) was slowly added, and the mixture reacted at room temperature for 6 h; then, the mixture was transferred into a single-neck flask equipped with a magnetic stirrer and a water separator, and 5 g of methylbenzene was added; and then the temperature was raised to 200°° C. for reflux for 4 h to obtain a polyimide solution.

Manufacturing example 3: Under the protection of N₂, 2.61 g of oxalyl dihydrazide (ADH), 3.78 g of 4,4-diaminodiphenyl ether (ODA) and 76.87 g of N-methylpyrrolidone were added into a three-necked flask for dissolution; after dissolution, 26.54 g of bisphenol A diether dianhydride (BPADA) was slowly added, and the mixture reacted at room temperature for 6 h; then, the mixture was transferred into a single-neck flask equipped with a magnetic stirrer and a water separator, and 5 g of methylbenzene was added; and then the temperature was raised to 200° C. for reflux for 4 h to obtain a polyimide solution.

Comparative manufacturing example 1: Under the protection of N₂, 10.01 g of 4,4-diaminodiphenyl ether (ODA) and 85.30 g of N-methylpyrrolidone were added into a three-necked flask for dissolution; after dissolution, 126.54 g of bisphenol A diether dianhydride (BPADA) was slowly added, and the mixture reacted at room temperature for 6 h; then, the mixture was transferred into a single-neck flask equipped with a magnetic stirrer and a water separator, and 5 g of methylbenzene was added; and then the temperature was raised to 200°° C. for reflux for 4 h to obtain a polyimide solution.

Comparative manufacturing example 2: Under the protection of N₂, 27.32 g of P1075 (Croda) and 98.75 g of N-methylpyrrolidone were added into a three-necked flask for dissolution; after dissolution, 15.01 g of 3,3′,4,4′-biphenyltetracarboxylic dianhydride (BPDA) was slowly added, and the mixture reacted at room temperature for 6 h; then, the mixture was transferred into a single-neck flask equipped with a magnetic stirrer and a water separator, and 5 g of methylbenzene was added; and then the temperature was raised to 200°° C. for reflux for 4 h to obtain a polyimide solution.

Mass ratios of various substances in Manufacturing examples 1-3 and Comparative manufacturing examples 1-2 are shown in Table 1 below, in which mass proportions of all amine materials are 100.

TABLE 1
Mass table of various substances in Manufacturing examples
1-3 and Comparative manufacturing examples 1-2

| | | | | Comparative | Comparative |
|---|---|---|---|---|---|
| | Manufac- | Manufac- | Manufac- | Manufac- | Manufac- |
| | turing | turing | turing | turing | turing |
| | example 1 | example 2 | example 3 | example 1 | example 2 |
| ADH | 30 | 30 | 30 | / | / |
| ODA | 70 | 70 | / | 100 | / |
| PDA | / | / | 70 | / | / |
| P1075 | / | / | / | / | 100 |
| ODPA | 102 | / | / | / | / |
| BPADA | / | 102 | 102 | 102 | 102 |

Specific embodiments and comparative examples for the preparation of a resin composition as an adhesive are as follows.

Embodiment 1-1:20 g of polyimide solution obtained in Manufacturing example 1 was taken, 0.18 g of hexamethylene diisocyanate (HDI) was added, and the mixture was mixed evenly to obtain an adhesive.

Embodiment 1-2:20 g of polyimide solution obtained in Manufacturing example 1 was taken, 0.18 g of tetrafunctional epoxy resin (AG80) was added, and the mixture was mixed evenly to obtain an adhesive.

Embodiment 2:20 g of polyimide solution obtained in Manufacturing example 2 was taken, 0.18 g of tetrafunctional epoxy resin (AG80) was added, and the mixture was mixed evenly to obtain an adhesive.

Embodiment 3:20 g of polyimide solution obtained in Manufacturing example 3 was taken, 0.18 g of tetrafunctional epoxy resin (AG80) was added, and the mixture was mixed evenly to obtain an adhesive.

Comparative example 1:20 g of polyimide solution obtained in Comparative manufacturing example 1 was taken, 0.18 g of tetrafunctional epoxy resin (AG80) was added, and the mixture was mixed evenly to obtain an adhesive.

Comparative example 2:20 g of polyimide solution obtained in Comparative manufacturing example 2 was taken, 0.18 g of tetrafunctional epoxy resin (AG80) was added, and the mixture was mixed evenly to obtain an adhesive.

The mass of each substance in Embodiments 1-3 and Comparative examples 1-2 is shown in Table 2 below.

TABLE 2
Table of the mass of various substances in Embodiments 1-3 and Comparative examples 1-2

| | | | | | Comparative | Comparative |
|---|---|---|---|---|---|---|
| | Embodiment 1-1 | Embodiment 1-2 | Embodiment 2 | Embodiment 3 | example 1 | example 2 |
| Manufacturing | 20 g | 20 g | / | / | / | / |
| example 1 | | | | | | |
| Manufacturing | / | / | 20 g | / | / | / |
| example 2 | | | | | | |
| Manufacturing | / | / | / | 20 g | / | / |
| example 3 | | | | | | |
| Comparative | / | / | / | / | 20 g | 20 g |
| manufacturing | | | | | | |
| example 1 | | | | | | |
| Comparative | | / | / | / | / | / |
| manufacturing | | | | | | |
| example 2 | | | | | | |
| HDI | 0.18 g | / | / | / | / | / |
| AG80 | / | 0.18 g | 0.18 g | 0.18 g | 0.18 g | 0.18 g |

In order to reflect the technical effects brought by the resin composition of the present invention, various tests were conducted on the above embodiments and comparative examples, and the specific test procedures and results are as follows.

1. The resin composition as an adhesive was applied to a copper foil and dried at 220°° C. for 3 min to obtain an adhesive sheet.

2. The resin composition as an adhesive was applied to a PI film (polyimide film) and dried at 220°° C. for 3 min to obtain an adhesive sheet.

3. The adhesive sheets obtained above were put together, aligning their adhesive surfaces face to face, and treated at 220° C. and 8 MPa for 20 min to obtain a copper-clad laminate.

4. The adhesive sheets with the PI film as a baseboard obtained above were put together, aligning their adhesive surfaces face to face, and treated at 220°° C. and 8 MPa for 20 min to obtain a resin multilayer board.

Peel strength testing: Following the IPC-TM-650-2.4.8 testing specification, samples were cut into 3.18 mm strips. The experiment was initiated on a testing machine with a pulling speed of 50 mm/min in a vertical direction until a minimum of 25.4 mm peel length was achieved, repeated 4 times to calculate the average value. The equipment used was a universal electronic testing machine (Shenzhen SUNS Co., Ltd.).

DMA testing: The equipment used for this test was the DMA850 from TA, conducted in tension mode.

Soldering resistance testing: According to the IPC-TM-650-2.4.13 testing specification, the aforementioned single-sided copper-clad laminate was cut into 50 mm×50 mm strips for soldering resistance testing.

Solubility in solvent: “+” means soluble; “++” represents good solubility.

Based on the above multiple tests, the test results of Embodiments 1-3 and Comparative examples 1-2 are shown in the following Table 3.

TABLE 3
Test results of Embodiments 1-3 and Comparative examples 1-2

| | | | | | Comparative | Comparative |
|---|---|---|---|---|---|---|
| | Embodiment 1-1 | Embodiment 1-2 | Embodiment 2 | Embodiment 3 | example 1 | example 2 |
| Adhesion | 0.87 | 0.95 | 0.99 | 0.89 | 0.55 | 0.92 |
| to PI | | | | | | |
| (N/mm) | | | | | | |
| Adhesion to | 0.95 | 1.01 | 1.21 | 0.97 | 0.67 | 1.01 |
| copper foil | | | | | | |
| (N/mm) | | | | | | |
| Tg | 231 | 240 | 235 | 238 | 215 | 94 |
| (DMA) | | | | | | |
| Soldering | OK | OK | OK | OK | OK | NG |
| resistance | | | | | | |
| Solubility | ++ | ++ | ++ | ++ | + | ++ |
| in NMP | | | | | | |

According to the test results of Embodiments 1-3 and Comparative example 1, the resin composition provided by the present invention has good adhesion and solubility while maintaining a suitable Tg (temperature resistance). Based on the test results of Embodiments 1-3 and Comparative example 2, it can be observed that the resin composition in the present invention exhibits a high Tg while maintaining good adhesion performance.

Foregoing descriptions are only optional embodiments of the present invention and are not intended to limit the present invention. Any modification, equivalent replacement, or improvement within spirit and principle of the present invention should be included in the protection scope of the present invention.

What is claimed is:

1. A resin composition, consisting of the following components:
polyimide which is a soluble product generated by a reaction of monomer groups containing aromatic tetracarboxylic dianhydride and diacid dihydrazide, a main chain of the polyimide containing a hydrazide structure; and
a curing agent which comprises one or more of multifunctional epoxy resin, a primary amine compound with three or more functional groups, and polyisocyanate, wherein a mass ratio of the curing agent to the soluble polyimide is 0-20%.

2. The resin composition according to claim 1, wherein a structural formula of the polyimide is as follows: 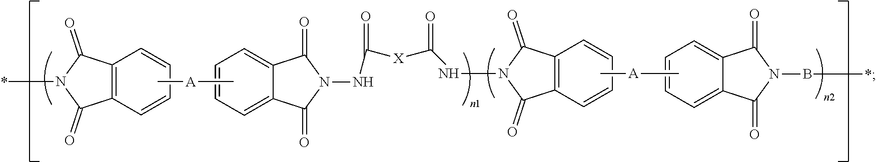
where, -A- is a dianhydride functional group, and the dianhydride functional group is one or more of phenyl whose bridging group is alkyl, ether, alkoxy, alkyl ester, carbonyl, sulphonyl, thioether or a group whose side chain has —H, alkyl, hydroxyl, fluorine and alkyl fluorine;
-B- is a diamine functional group, and the diamine functional group is any one of diphenylamine whose bridging group is long-chain alkyl, long-chain alkoxy or long-chain alkyl and long-chain alkoxy with branched structures; and
-X- is —(CH₂)ₘ- or a phenyl group with pendant groups, and m is an integer between 0 and 6.

3. The resin composition according to claim 2, wherein the number of carbon atoms of the alkyl and the alkoxy is 0-20.

4. The resin composition according to claim 1, wherein the multifunctional epoxy resin is one of bisphenol S epoxy resin, bisphenol F epoxy resin, polyglycidyl ether epoxy resin, aliphatic glycidyl ether epoxy resin and glycidyl ester epoxy resin.

5. The resin composition according to claim 4, wherein a structural formula of the multifunctional epoxy resin is as follows: 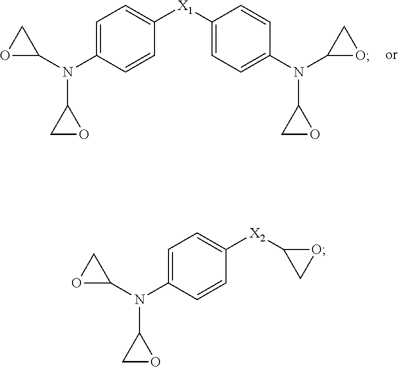
where, X₁ and X₂ are each one of —,O—, alkyl, alkoxy, alkylphenyl and alkylphenoxy.

6. The resin composition according to claim 1, wherein the primary amine compound with three or more functional groups is one of melamine, semicarbazide and dicyandiamide.

7. The resin composition according to claim 1, wherein the polyisocyanate is one of toluene diisocyanate, diphenylmethane diisocyanate, isophorone diisocyanate, hexamethylene diisocyanate, dicyclohexylmethane diisocyanate, naphthalene diisocyanate, 1,4-phenylene diisocyanate, diphenylmethylene diisocyanate, cyclohexanedimethylene diisocyanate, trimethyl-1,6-hexamethylene diisocyanate, tetramethyl m-xylylene diisocyanate, norbornane diisocyanate, dimethylbiphenyl diisocyanate, methylcyclohexyl diisocyanate and dimers or trimers thereof.

8. A polyimide preparation method, wherein polyimide is the polyimide in the resin composition according to claim 2, and the polyimide preparation method comprises the following steps:
S1, firstly dissolving diamine and long-chain dihydrazide in a solvent, then adding dianhydride, and then reacting at a first preset temperature for a first preset time, to synthesize polyamic acid with a hydrazide structure in a main chain; and
S2, adding a water-carrying agent or a catalyst into the polyamic acid with the hydrazide structure in the main chain, and then reacting at a second preset temperature for a second preset time, to obtain the soluble polyimide with the hydrazide structure.

9. The polyimide preparation method according to claim 8, wherein a molar ratio of the dianhydride, the diamine and the long-chain dihydrazide is 0.95-1.3:0-1:0.05-0.6, and a molar ratio of the dianhydride to the diamine plus the long-chain dihydrazide is greater than 0.95 and less than or equal to 1.3.

10. The polyimide preparation method according to claim 8, wherein the first preset temperature is −20-50°° C., the first preset time is 1-48 h, the second preset temperature is 140-280° C., and the second preset time is 0.5-10 h.

11. The polyimide preparation method according to claim 8, wherein the diamine is diamine with the-B-structure; and the diamine is one of more of 4,4-diaminodiphenyl ether, 3,4-diaminodiphenyl ether, 2,2-bis[4-(4-aminophenoxy)phenyl]propane, 1,3-bis(3-aminophenoxy)benzene, 1,3-bis(4-aminophenoxy) benzene, 1,4-bis(4-aminophenoxy)benzene, 2,2′-bis(trifluoromethyl)-4,4′-diaminophenyl ether, 2,2-bis(3-amino-4-hydroxyphenyl)hexafluoropropane, 2,2-bis(4-hydroxy-3-aminophenyl)propane, 4,4′-bis(3-aminophenoxy) diphenyl sulfone, 4-aminobenzoic acid 4-aminophenyl ester, [4-(4-aminobenzoyl)phenoxy]4-aminobenzoic acid ester, and 1,4-bis(4-amino-2-trifluoromethylphenoxy)benzene.

12. The polyimide preparation method according to claim 8, wherein the long-chain dihydrazide is dihydrazide with the -X- structure; and the long-chain dihydrazide is one or more of maleic dihydrazide, glutaric dihydrazide, succinic dihydrazide, adipic dihydrazide, carbohydrazide, oxalyl dihydrazide, and N,N′-(2,2′-bis(trifluoromethyl)-[1,1′-biphenyl]-4,4′-diyl) bis(4-aminobenzamide).

13. The polyimide preparation method according to claim 8, wherein the dianhydride is dianhydride with the -A- structure; and the dianhydride is one or more of 4,4-oxydiphthalic anhydride, bisphenol A diether dianhydride, p-phenylene-trimellitate dianhydride, hexafluorodianhydride, 3,3,4,4-benzophenone tetracarboxylic dianhydride, 4,4′-diphenyl ether dianhydride and 3,3,4,4-diphenyl sulfone tetracarboxylic dianhydride.

14. The polyimide preparation method according to claim 8, wherein the solvent is one or more of toluene, xylene, dioxane, tetrahydrofuran, methanol, ethanol, acetone, butanone, cyclohexanone, N,N-dimethylformamide, N,N-dimethylacetamide and N-methylpyrrolidone.

15. The polyimide preparation method according to claim 8, wherein the water-carrying agent is one or more of benzene, toluene and xylene; and the catalyst is one of triethylamine, pyridine and isoquinoline liquid, with a boiling point less than 200° C.

16. An adhesive, comprising a solvent, a curing accelerator and the resin composition according to claim 1, wherein a mass proportion of the resin composition in the adhesive is 10%-40%, a mass proportion of the curing accelerator in the adhesive is 0%-10%, and the balance is the solvent.

17. The adhesive according to claim 16, wherein polyimide in the resin composition is prepared by the polyimide preparation method according to claim 8.

18. An adhesive layer, comprising a support and the resin composition according to claim 1 applied to the support.

19. A copper foil with resin, comprising a copper foil and the adhesive according to claim 16 applied to the copper foil.
